(19) United States
(12) Patent Application Publication
(10) Pub. No.: US 2025/0316906 A1
(43) Pub. Date: Oct. 9, 2025

(54) MULTI-BAND MULTI-CHANNEL PHASE SHIFTER AND MULTI-BAND DUAL-POLARIZED ANTENNA

(71) Applicants: Jiangsu Hengxin Technology Co., Ltd., Yixing (CN); Jiangsu Hengxin Wireless Technology Co., Ltd., Yixing (CN)

(72) Inventors: Ping HUANG, Yixing (CN); Shu LI, Yixing (CN); Wei CHEN, Yixing (CN); Weibiao XU, Yixing (CN); Xuefeng CUI, Yixing (CN); Donglin HAN, Yixing (CN); Jianjun SU, Yixing (CN)

(73) Assignees: Jiangsu Hengxin Technology Co., Ltd., Yixing (CN); Jiangsu Hengxin Wireless Technology Co., Ltd., Yixing (CN)

(21) Appl. No.: 19/027,944

(22) Filed: Jan. 17, 2025

Related U.S. Application Data
(63) Continuation of application No. PCT/CN2024/118213, filed on Sep. 11, 2024.

(30) Foreign Application Priority Data
Apr. 7, 2024 (CN) 2024104068948

(51) Int. Cl. H01Q 13/08; H01Q 3/26; H01Q 5/30

(52) U.S. Cl. CPC H01Q 13/08; H01Q 3/2694; H01Q 5/30

(57) ABSTRACT

The present invention discloses a multi-band multi-channel phase shifter and a multi-band dual-polarized antenna, including a metal cavity, where the metal cavity is internally provided with a transverse rib to be separated into two upper and lower hollow cavities that are independent, and two upper and lower side surfaces of the transverse rib are provided with separators toward the hollow cavities respectively; the separators include parallel walls that are parallelly arranged at intervals relative to the transverse rib, and a vertical wall is connected between the parallel wall and the transverse rib; and a metal strip line of an integrated structure is mounted in a single hollow cavity respectively, and the metal strip line includes a combining section and a phase shifting section that are parallel to each other.

### CROSS-REFERENCE TO RELATED APPLICATIONS

The application claims priority to Chinese patent application No. 2024104068948, filed on Apr. 7, 2024, the entire contents of which are incorporated herein by reference.

### TECHNICAL FIELD

The present invention relates to the technical field of mobile communication antennas, and in particular, to a multi-band multi-channel phase shifter and a multi-band dual-polarized antenna.

### BACKGROUND

With the development of base station antennas, multi-band multi-mode antennas have gradually become mainstream. To ensure the quality of communication, the antennas mostly adopt the form of orthogonal polarization.

With the complex evolution of antenna systems, feed networks usually need to integrate more and more functions. Since the cavity phase shifter adopts the transmission form of air strip lines, it has obvious advantages over other phase shifting forms in reducing network losses and improving the radiation efficiency of the antenna feed system.

To implement the multi-band phase shifter, most of the existing technologies consider accommodating the combiner and the phase shifter in one cavity, and the cavity is internally partitioned according to different bands or different functions. When it is necessary to implement the dual-polarized antenna, the cavity is usually arranged in a stacked or arrayed manner. The existing split stacked structural form is relatively complex and occupies large space.

### SUMMARY

To solve the above problems, the present invention provides a multi-band multi-channel phase shifter and a multi-band dual-polarized antenna with reasonable structures, thereby effectively reducing mounting assemblies in an existing stacked structure, facilitating assembling, and particularly, saving space in an internal thickness direction of a cavity.

Technical solutions adopted by the present invention are as follows:

A multi-band multi-channel phase shifter, including a metal cavity, including a metal cavity, where the metal cavity is internally provided with a transverse rib to be separated into two upper and lower hollow cavities that are independent and symmetrically distributed, and two upper and lower side surfaces of the transverse rib are provided with separators toward the hollow cavities respectively; the separators include parallel walls that are parallelly arranged at intervals relative to the transverse rib, and a vertical wall is connected between the parallel wall and the transverse rib; and a metal strip line of an integrated structure is mounted in a single hollow cavity respectively, and the metal strip line includes a combining section and a phase shifting section that are parallel to each other.

As a further improvement of the above technical solution:

A region between the parallel wall and an inner wall surface of the metal cavity forms a combiner wiring region, a region between the parallel wall and the transverse rib is separated into two phase shifting function regions through the vertical wall, and the two phase shifting function regions are in space communication with the combiner wiring region; and the vertical wall is vertically located on a middle portion of the transverse rib and a middle portion of the parallel wall.

A single metal strip line includes two phase shifting sections located on a same plane and separated from each other, and the two phase shifting sections are located in the phase shifting function regions on two sides of the vertical wall; and the two phase shifting sections are connected to edges on two sides of the combining section through a connecting portion respectively, to form the metal strip line that is integrally formed.

The connecting portion is vertical to a plane on which the combining section is located and a plane on which the phase shifting section is located, and edges oppositely arranged on the connecting portion are connected to the combining section and the phase shifting section respectively; and a plurality of connecting portions are respectively arranged at intervals along length directions of the edges on the two sides of the combining section.

A dielectric block is assembled between at least one side surface of a single phase shifting section and a corresponding parallel wall or transverse rib, and a pull rod assembly pulls the dielectric block, to generate relative displacement between the dielectric block and the phase shifting section, to generate phase shifting.

A concave-convex assembling structure is disposed between the parallel wall and an attached dielectric block, and the concave-convex assembling structure guides displacement of the dielectric block relative to the phase shifting section.

The combining section is located in a combiner wiring region that is between the parallel wall and an inner wall surface of the metal cavity, and a strip line support is assembled between an upper side surface of the combining section and the inner wall surface of the metal cavity and between a lower side surface of the combining section and the parallel wall respectively.

The vertical wall is vertically connected between the parallel wall and the transverse rib, and the parallel wall and the vertical wall form the separator of a T-shaped structure; or
two vertical walls arranged at intervals are vertically connected between the parallel wall and the transverse rib; and
a transverse rib between the two vertical walls is communicated or separated.

A middle portion of a top surface edge of the metal cavity is provided with an input end welding window, and an input end welding open window is provided below the input end welding window and corresponding to the two hollow cavities; and a top surface edge, located on each of two sides of the input end welding window, of the metal cavity is provided with an output end welding window, and an output end welding open window is provided below the output end welding window and corresponding to the two hollow cavities.

A multi-band dual-polarized antenna, including the multi-band multi-channel phase shifter according to any one of the above, where a phase shifter is formed in two hollow cavities of a metal cavity respectively, and an input signal excites a radiation array through two phase shifters respectively.

Compared with the prior art, the present invention has the following beneficial effects:

The present invention is compact and reasonable in structure and is convenient and reliable to use, and the metal strip line of the integrated structure is mounted through the metal cavity, so that assembling is convenient, mounting assemblies in the existing stacked structure are effectively reduced, and particularly, space in the internal thickness direction of the cavity is saved. The phase shifter of the present invention can support at least two bands and support a dual-polarized base station antenna design.

The present invention further includes the following advantages:

In the present invention, an existing two-dimensional strip line is converted into a three-dimensional transmission line for use in space by using ductility of the metal strip line, so that discontinuity of connections between different layers is reduced, product manufacturability is improved, and environmental pollution is reduced.

The phase shifter is of an integrated structure and is provided with the metal strip line of the integrated structure through the metal cavity, forming multiple bands and multiple channels, which reduces product assembling and layout difficulty, saves antenna surface space, reduces antenna weight, and is of positive significant to reduce an antenna windward area.

### BRIEF DESCRIPTION OF THE DRAWINGS

FIG. 1 is a schematic structural diagram of a phase shifter according to the present invention;

FIG. 2 is a side view of a phase shifter according to the present invention;

FIG. 3 is a partial enlarged view of a position A in FIG. 2;

FIG. 4 is a schematic structural diagram of a metal cavity in a first embodiment according to the present invention;

FIG. 5 is a schematic structural diagram of a metal cavity in a second embodiment according to the present invention;

FIG. 6 is a schematic structural diagram of a metal cavity in a third embodiment according to the present invention;

FIG. 7 is an exploded view of a phase shifter according to the present invention;

FIG. 8 is a partial enlarged view of a position B in FIG. 7;

FIG. 9 is a partial enlarged view of a position C in FIG. 7;

FIG. 10 is a schematic structural diagram (a metal cavity and a transverse rib are omitted) of a phase shifter according to the present invention;

FIG. 11 is a partial enlarged view of a position D in FIG. 10; and

FIG. 12 is a schematic working diagram of a multi-band dual-polarized antenna according to the present invention.

1. metal cavity; 2. pull rod assembly; 3. strip line support; 4. metal strip line; 5. separator; 6. dielectric block; 7. concave-convex assembling structure;

10. transverse rib; 11. output end welding window; 12. output end welding open window; 13. input end welding window; 14. input end welding open window;

41. combining section; 42. connecting portion; 43. phase shifting section;

50. concave groove; 51. parallel wall; 52. vertical wall;

61. convex ledge.

### DETAILED DESCRIPTION OF THE EMBODIMENTS

The specific embodiments of the present invention are described below with reference to the accompanying drawings.

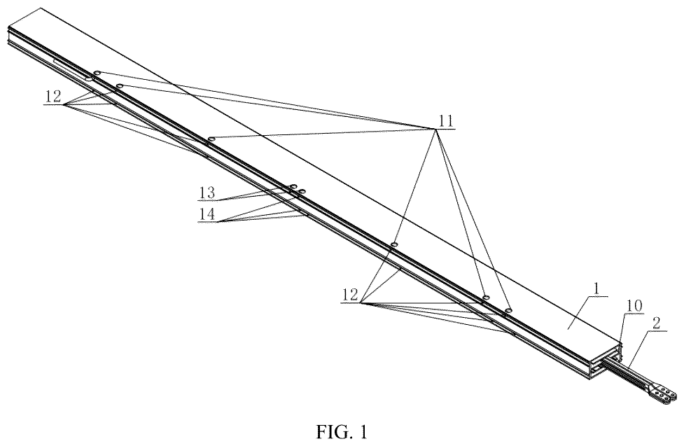

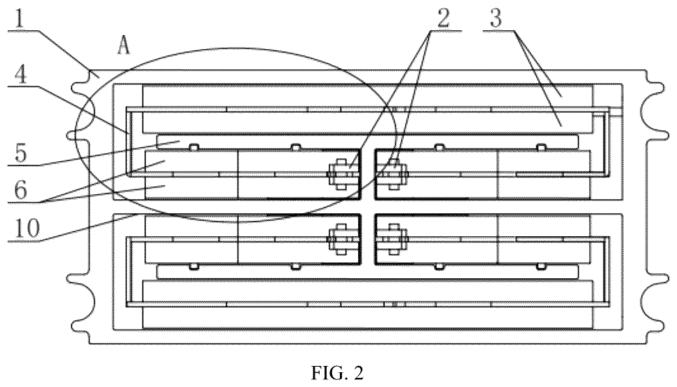

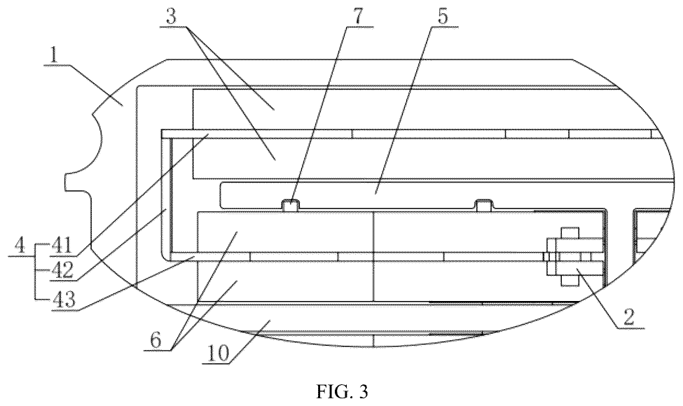

As shown in FIG. 1 and FIG. 2, a multi-band multi-channel phase shifter of an embodiment includes a metal cavity 1. The metal cavity 1 is internally provided with a transverse rib 10 to be separated into two upper and lower hollow cavities that are independent and symmetrically distributed, and two upper and lower side surfaces of the transverse rib 10 are provided with separators 5 toward the hollow cavities respectively. The separators 5 include parallel walls 51 that are parallelly arranged at intervals relative to the transverse rib 10, and a vertical wall 52 is connected between the parallel wall 51 and the transverse rib 10. A metal strip line 4 of an integrated structure is mounted in a single hollow cavity respectively, and as shown in FIG. 3, the metal strip line 4 includes a combining section 41 and a phase shifting section 43 that are parallel to each other.

In the embodiment, the metal strip line 4 of the integrated structure is mounted through the metal cavity 1, so that assembling is convenient, mounting assemblies in an existing stacked structure are effectively reduced, and particularly, space in an internal thickness direction of the cavity is saved.

In the embodiment, the metal cavity 1 is separated into two independent hollow cavities by the transverse rib 10. A single hollow cavity is separated by the separator 5 to adapt to the combining section 41 and the phase shifting section 43 of the metal strip line 4, thereby greatly helping form the multi-band multi-channel phase shifter. Therefore, an overall structure is compact, and arrangement is simple and ingenious.

A region between the parallel wall 51 and an inner wall surface of the metal cavity 1 forms a combiner wiring region. A region between the parallel wall 51 and the transverse rib 10 is separated into two phase shifting function regions through the vertical wall 52. The two phase shifting function regions are symmetrically arranged. The two phase shifting function regions are in space communication with the combiner wiring region. The vertical wall 52 is vertically located on a middle portion of the transverse rib 10 and a middle portion of the parallel wall 51.

In the embodiment, the phase shifting function regions are in space communication with the combiner wiring region, so that the metal strip line 4 may be placed in a communicated hollow cavity region without obstructions, and assembling is facilitated. Particularly, the two phase shifting function regions are formed on two sides of the vertical wall 52 of the single hollow cavity, and assembling of the phase shifting section 43 of the metal strip line 4 is combined, so that a dual-band structure is formed in the single hollow cavity.

In the embodiment, the single hollow cavity of the metal cavity 1 is separated by the separator 5 into two internal regions communicated with each other, that is, the combiner wiring region and the phase shifting function region. The interior of the single hollow cavity may be considered as a folded single-layer wide-opening cavity. The combiner wiring region and the phase shifting function region perform transmission and energy distribution on a polarized signal of an antenna respectively.

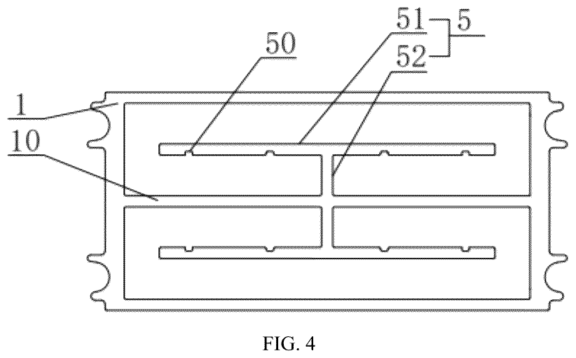

In an embodiment shown in FIG. 4, the vertical wall 52 is vertically connected between the parallel wall 51 and the transverse rib 10, and the parallel wall 51 and the vertical wall 52 form the separator 5 of a T-shaped structure. Therefore, the two phase shifting function regions that are symmetrical are formed on the two sides of the vertical wall 52.

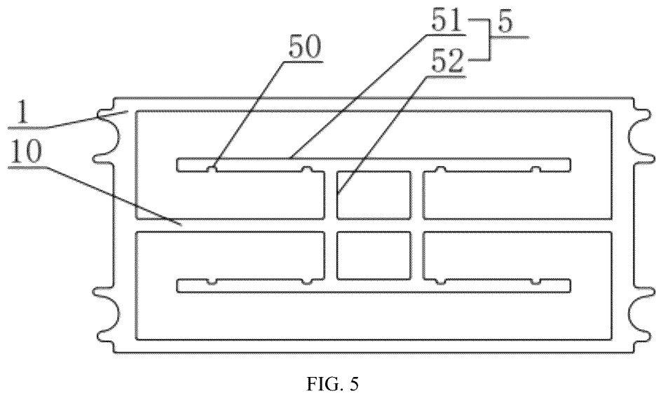

In an embodiment shown in FIG. 5, two vertical walls 52 arranged at intervals are vertically connected between the parallel wall 51 and the transverse rib 10. Therefore, the two phase shifting function regions that are symmetrical are formed on outer sides of the two vertical walls 52.

A transverse rib 10 between the two vertical walls 52 is communicated, and the transverse rib 10 is combined with vertical walls 52 on two sides and upper and lower parallel walls 51 in two separators 5 to form a structure of a shape of two stacked squares.

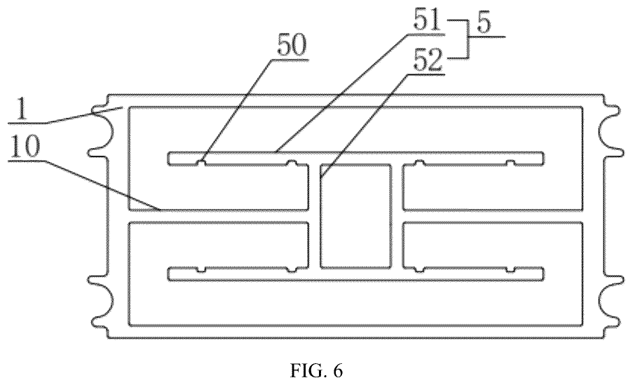

In an embodiment shown in FIG. 6, based on a structural form in FIG. 5, a transverse rib 10 between the two vertical walls 52 is separated, and vertical walls 52 on two sides and upper and lower parallel walls 51 in two separators 5 form a structure of a square shape.

In the embodiment, the transverse rib 10 and the metal cavity 1 are of an integrated structure and are formed through pressing or squeezing at one time.

A single metal strip line 4 includes two phase shifting sections 43 located on a same plane and separated from each other. The two phase shifting sections 43 are located in the phase shifting function regions on the two sides of the vertical wall 52. Phase shifting networks at two different bands such as a band 1 and a band 2 may be formed. The two phase shifting sections 43 are connected to edges on two sides of the combining section 41 through a connecting portion 42 respectively, to form the metal strip line 4 that is integrally formed.

In the embodiment, an existing two-dimensional strip line is converted into a three-dimensional transmission line for use in space by using ductility of the metal strip line 4, so that discontinuity of connections between different layers is reduced, product manufacturability is improved, and environmental pollution is reduced.

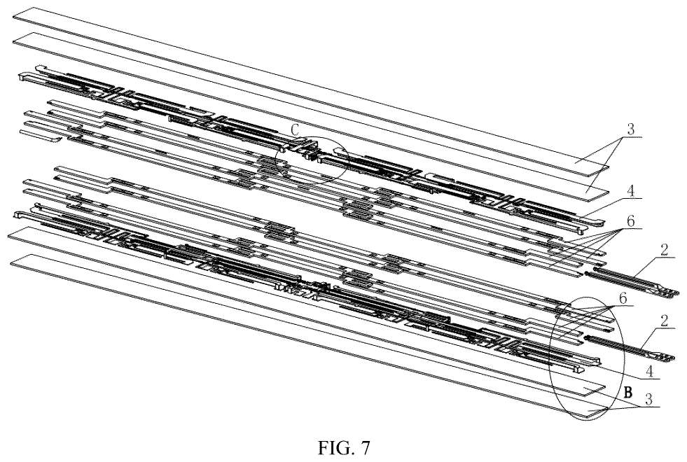

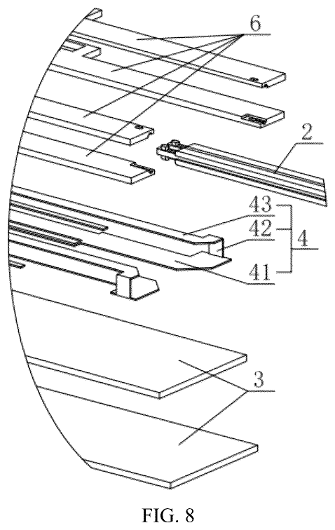

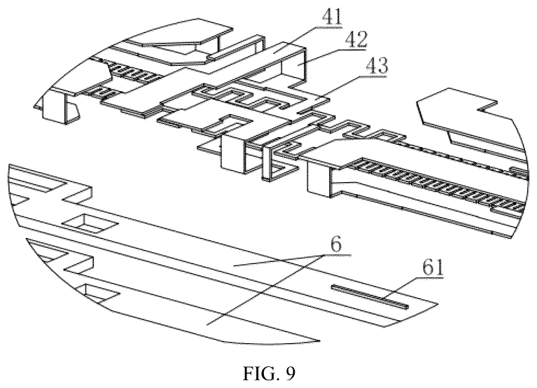

The connecting portion 42 is vertical to a plane on which the combining section 41 is located and a plane on which the phase shifting section 43 is located, and edges oppositely arranged on the connecting portion 42 are connected to the combining section 41 and the phase shifting section 43 respectively. As shown in FIG. 7, FIG. 8, and FIG. 9, a plurality of connecting portions 42 are respectively arranged at intervals along length directions of the edges on the two sides of the combining section 41.

In the embodiment, the metal strip line 4 is integrally formed and assembled, and welding is not required for internal switching. Compared with an existing metal line structure arranged flatly, the structural form in the embodiment occupies a smaller back area, reducing a problem of tight arrangement space and difficult assembling of other components and lines on a back surface.

A dielectric block 6 is assembled between at least one side surface of a single phase shifting section 43 and a corresponding parallel wall 51 or/and transverse rib 10. A pull rod assembly 2 pulls the dielectric block 6, and an outer end of the pull rod assembly 2 is connected to a transmission assembly, to generate relative displacement between the dielectric block 6 and the phase shifting section 43, thereby generating phase shifting.

In the embodiment, the dielectric block 6 implements the phase shifting during displacement relative to the phase shifting section 43, and the dielectric block 6 further plays a role in supporting, protecting, and transversely limiting the metal strip line 4.

During actual use, the dielectric block 6 may be mounted on any single side or two sides of the phase shifting section 43. The relative displacement of the dielectric block 6 generates the phase shifting, and the dielectric block 6 supports the metal strip line 4.

In the embodiment, in the two phase shifting function regions that are on the two sides of the vertical wall 52 and that are located in the same hollow cavity, two groups of dielectric blocks 6 corresponding to the two phase shifting sections 43 of the metal strip line 4 may be led out by the pull rod assembly 2 respectively, and power transmission is performed by the same transmission assembly, so that the overall structure is more compact. At this time, two groups of left and right pull rod assemblies 2 may be close to each other and arranged on the two sides of the vertical wall 52.

Certainly, in actual use, power transmission may be performed on the two groups of left and right dielectric blocks 6 and the two groups of left and right pull rod assemblies 2 by different transmission assemblies according to actual use requirements.

The pull rod assembly 2 is mounted on end portions of two dielectric blocks 6 on two sides of the same phase shifting section 43 jointly. For two upper and lower dielectric blocks 6 in the same group, an end portion of the pull rod assembly 2 may be provided with a boss penetrating up and down. Two upper and lower bosses are assembled with the two upper and lower dielectric blocks 6 for mounting, thereby facilitating driving the two dielectric block 6 to move synchronously through movement of the pull rod assembly 2.

A concave-convex assembling structure 7 is disposed between the parallel wall 51 and an attached dielectric block 6, and the concave-convex assembling structure 7 guides the displacement of the dielectric block 6 relative to the phase shifting section 43.

In the embodiment, the concave-convex assembling structure 7 is disposed to transversely limit the dielectric block 6 and play a guide role during the displacement of the dielectric block 6 relative to the phase shifting section 43.

In an embodiment shown in FIG. 9, a side surface, facing the parallel wall 51, of the dielectric block 6 is provided with a convex ledge 61, and a side surface, facing the dielectric block 6, of the parallel wall 51 is provided with a concave groove 50. As shown in FIG. 4, FIG. 5, and FIG. 6, the convex ledge 61 and the concave groove 50 are assembled in a matching manner, to form the concave-convex assembling structure 7, thereby implementing guidance in relative displacement.

Certainly, in an actual operation, the side surface of the dielectric block 6 may also be provided with a groove, and the parallel wall 51 may be provided with a ledge. The groove and the ledge are matched to form the concave-convex assembling structure 7.

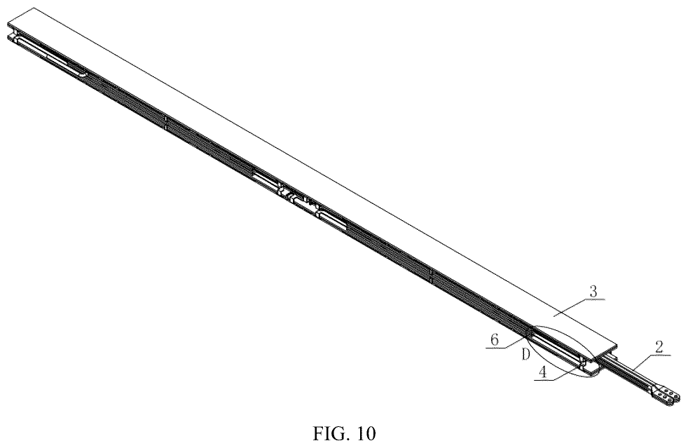

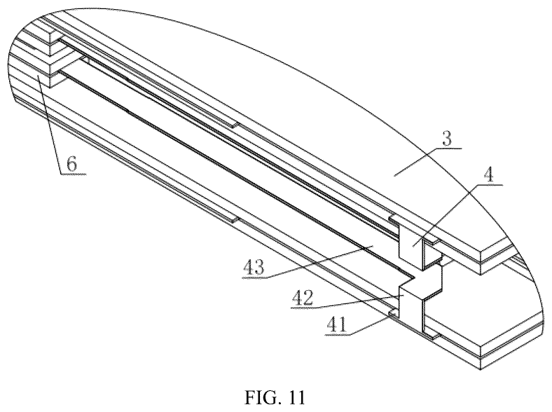

As shown in FIG. 10 and FIG. 11, the combining section 41 is located in the combiner wiring region that is between the parallel wall 51 and an inner wall surface of the metal cavity 1, and a strip line support 3 is assembled between an upper side surface of the combining section 41 and the inner wall surface of the metal cavity 1 and between a lower side surface of the combining section and the parallel wall 51 respectively.

In the embodiment, the strip line support 3 may be a structure made of sponge, foam, plastic, or other materials, to play a support and shape protection role for the metal strip line 4.

In the embodiment, the metal strip line 4 of a three-dimensional space structure is supported by the strip line support 3 and the dielectric block 6 jointly and is arranged in the combiner wiring region and the phase shifting function region, so that a structural form of the metal strip line 4 is effectively ensured, the metal strip line 4 is arranged reliably and stably around the separator 5, and the metal strip line 4 is not in contact with a cavity wall of the metal cavity 1.

A middle portion of a top surface edge of the metal cavity 1 is provided with an input end welding window 13, and an input end welding open window 14 is provided below the input end welding window 13 and corresponding to the two hollow cavities. A top surface edge, located on each of two sides of the input end welding window 13, of the metal cavity 1 is provided with an output end welding window 11, and an output end welding open window 12 is provided below the output end welding window 11 and corresponding to the two hollow cavities.

In the embodiment, the input end welding window 13 and the output end welding window 11 are used to weld an inner conductor of a cable. The input end welding open window 14 and the output end welding open window 12 are used to be connected to an antenna radiation unit through a cable network.

The phase shifter is of an integrated structure and is provided with the metal strip line 4 of the integrated structure through the metal cavity 1, forming multiple bands and multiple channels, which reduces product assembling and layout difficulty, saves antenna surface space, reduces antenna weight, and is of positive significant to reduce an antenna windward area.

In an actual operation, the metal strip line 4 may be implemented by using a sheet metal process and bent and formed along a bending line, which is simple in structure and convenient in forming. Then the metal strip line 4 is placed in a corresponding hollow cavity of the metal cavity 1 in a preset form, which is conducive to wiring mounting.

The metal cavity 1 and the transverse rib 10 are of an integrally-formed structure, which may be generated by using a die-casting mold or profile cavity pultrusion, have a low manufacturing cost, and are suitable for mass production.

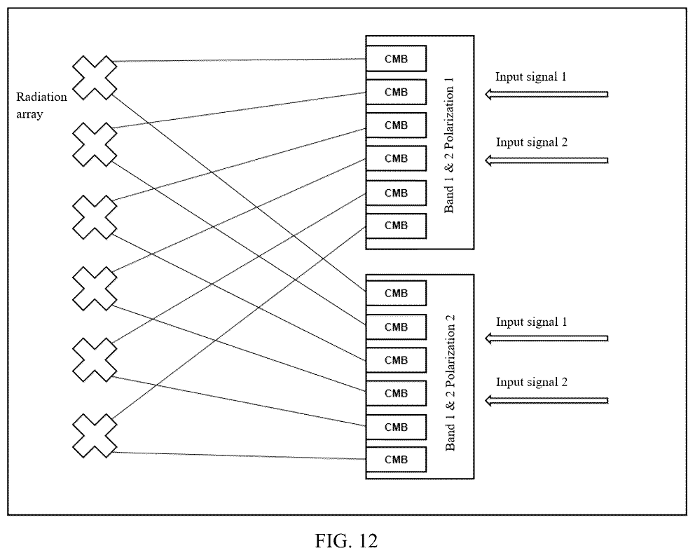

A multi-band dual-polarized antenna of an embodiment includes the multi-band multi-channel phase shifter according to any one of the above. A phase shifter is formed in two hollow cavities of a metal cavity 1 respectively, and as shown in FIG. 12, an input signal excites a radiation array through two phase shifters respectively.

The present invention is compact, reasonable, and ingenious in structure, supports and implements the multi-band dual-polarized antenna, and effectively reduces mounting assemblies in a stacked structure of an existing phase shifter, thereby saving space in an internal thickness direction of the cavity and greatly facilitating assembling.

Various embodiments in the specification are described in a progressive manner, and each embodiment focuses on the differences from the other embodiments, and the same or similar parts between the various embodiments can refer to each other.

The above description is an explanation of the present invention and is not intended to limit the present invention. The scope limited by the present invention refers to the claims, and any form of modification may be made within the protection scope of the present invention.

What is claimed is:

1. A multi-band multi-channel phase shifter, comprising a metal cavity (1), wherein the metal cavity (1) is internally provided with a transverse rib (10) to be separated into two upper and lower hollow cavities that are independent, and two upper and lower side surfaces of the transverse rib (10) are provided with separators (5) toward the hollow cavities respectively; the separators (5) comprise parallel walls (51) that are parallelly arranged at intervals relative to the transverse rib (10), and a vertical wall (52) is connected between the parallel wall (51) and the transverse rib (10); and a metal strip line (4) of an integrated structure is mounted in a single hollow cavity respectively, and the metal strip line (4) comprises a combining section (41) and a phase shifting section (43) that are parallel to each other.

2. The multi-band multi-channel phase shifter according to claim 1, wherein a region between the parallel wall 51 and an inner wall surface of the metal cavity (1) forms a combiner wiring region, a region between the parallel wall (51) and the transverse rib (10) is separated into two phase shifting function regions through the vertical wall (52), and the two phase shifting function regions are in space communication with the combiner wiring region; and the vertical wall (52) is vertically located on a middle portion of the transverse rib (10) and a middle portion of the parallel wall (51).

3. The multi-band multi-channel phase shifter according to claim 1, wherein a single metal strip line (4) comprises two phase shifting sections (43) located on a same plane and separated from each other, and the two phase shifting sections (43) are located in the phase shifting function regions on two sides of the vertical wall (52); and the two phase shifting sections (43) are connected to edges on two sides of the combining section (41) through a connecting portion (42) respectively, to form the metal strip line (4) that is integrally formed.

4. The multi-band multi-channel phase shifter according to claim 3, wherein the connecting portion (42) is vertical to a plane on which the combining section (41) is located and a plane on which the phase shifting section (43) is located, and edges oppositely arranged on the connecting portion (42) are connected to the combining section (41) and the phase shifting section (43) respectively; and a plurality of connecting portions (42) are respectively arranged at intervals along length directions of the edges on the two sides of the combining section (41).

5. The multi-band multi-channel phase shifter according to claim 3, wherein a dielectric block (6) is assembled between at least one side surface of a single phase shifting section (43) and a corresponding parallel wall (51) or transverse rib (10), and a pull rod assembly (2) pulls the dielectric block (6), to generate relative displacement between the dielectric block (6) and the phase shifting section (43), to generate phase shifting.

6. The multi-band multi-channel phase shifter according to claim 5, wherein a concave-convex assembling structure (7) is disposed between the parallel wall (51) and an attached dielectric block (6), and the concave-convex assembling structure (7) guides displacement of the dielectric block (6) relative to the phase shifting section (43).

7. The multi-band multi-channel phase shifter according to claim 1, wherein the combining section (41) is located in a combiner wiring region that is between the parallel wall 51 and an inner wall surface of the metal cavity (1), and a strip line support (3) is assembled between an upper side surface of the combining section (41) and the inner wall surface of the metal cavity (1) and between a lower side surface of the combining section and the parallel wall (51) respectively.

8. The multi-band multi-channel phase shifter according to claim 1, wherein the vertical wall (52) is vertically connected between the parallel wall (51) and the transverse rib (10), and the parallel wall (51) and the vertical wall (52) form the separator (5) of a T-shaped structure; or
two vertical walls (52) arranged at intervals are vertically connected between the parallel wall (51) and the transverse rib (10); and
a transverse rib (10) between the two vertical walls (52) is communicated or separated.

9. The multi-band multi-channel phase shifter according to claim 1, wherein a middle portion of a top surface edge of the metal cavity (1) is provided with an input end welding window (13), and an input end welding open window (14) is provided below the input end welding window (13) and corresponding to the two hollow cavities; and a top surface edge, located on each of two sides of the input end welding window (13), of the metal cavity (1) is provided with an output end welding window (11), and an output end welding open window (12) is provided below the output end welding window (11) and corresponding to the two hollow cavities.

10. A multi-band dual-polarized antenna, comprising the multi-band multi-channel phase shifter according to claim 1, wherein a phase shifter is formed in two hollow cavities of a metal cavity (1) respectively, and an input signal excites a radiation array through two phase shifters respectively.
